(19) United States
(12) Patent Application Publication
(10) Pub. No.: US 2004/0143443 A1
(43) Pub. Date: Jul. 22, 2004

(54) System to detect unauthorized signal processing of audio signals

(76) Inventors: Panos Kudumakis, London (GB); Stathis Voukelatos, Middlesex (GB)

Correspondence Address: FLEIT KAIN GIBBONS GUTMAN & BONGINI, COURVOISIER CENTRE II, SUITE 404, 601 BRICKELL KEY DRIVE, MIAMI, FL, 33131, US

(21) Appl. No.: 10/690,220

(22) Filed: Oct. 20, 2003

Related U.S. Application Data
(63) Continuation of application No. PCT/GB02/01914, filed on Apr. 25, 2002.

(30) Foreign Application Priority Data
Apr. 25, 2001 (GB) 0110132.8

(51) Int. Cl. G10L 19/00

(52) U.S. Cl. 704/500

(57) ABSTRACT

A system for detecting a first type of signal processing having been applied to audio signals that employs an encoder for imposing upon the audio signals, in a predetermined relationship, first coding signals robust against the first type of signal processing, and second coding signals vulnerable to contamination by noise when subjected to said first type of signal processing. A detector is conditioned to reject signals contaminated by the noise. A comparator compares the relationship between first and second coding signals as received in order to detect variation in the predetermined relationship, and thereby to discern whether unauthorized signal processing of the first type has been applied to audio signals received by way of the communications channel. The second coding signals are robust against other types of signal processing.

### RELATED APPLICATION

This application is a continuation of International PCT Application PCT No. PCT/GB 02/01914, filed Apr. 25, 2002, the contents of which are here incorporated in their entirety.

### BACKGROUND OF THE INVENTION

Field of the Invention

This invention is concerned with the detection of unauthorized signal processing of audio signals. In particular, it relates to a system for detecting whether audio signals that bear identity coding, such as that known as “watermark” coding for the purposes of indicating copyright ownership, have been compressed prior to its emergence from a communication channel such as the Internet. Such compression can indicate that the copyright material has been compromised prior to and/or during transmission through the communications channel, and thus that the transmission in question has not been made by, or with the permission of, the copyright owner.

A reliable indication that unauthorized compression has taken place can be used to prevent storage, such as by recording, and replication of the audio program in question.

There are various criteria to be taken into account when devising a system that is capable of effecting discrimination of the kind described. Importantly, the system should not require the audio material to be processed in any way that will compromise its enjoyment by authorized listeners. Moreover, it is important that the system does not indicate that unauthorized compression has taken place when, in fact, it has not. For example, it is important that other bona fide editorial functions, such as re-sampling, equalization, digital-to-analog conversion and down-mixing, are permitted to occur.

A well-established and robust process for “watermarking” audio signals is that devised by the present applicants, as represented for example in the specifications of their European patent applications Nos. 0 245 037; 0 366 381 and 0 801855. These techniques are commercially known as “ICE”, and are based upon embedding identifying codes inaudibly within one or more notches made at one or more specific frequencies in the overall content of the audio signal program. As is known from the aforementioned specifications, the codes are only inserted when the program content is sufficient to mask the insertion, and when program signal breakthrough into the notch, or notches, is insufficient to interfere with reliable detection of the codes. It is also known that the codes can be subjected to pseudo-random hopping from one insertion notch to another, in order to further frustrate those who would attempt to subvert the coding.

These known expedients serve to render the watermarking robust, and thus, of its very nature, inclined to survive various processing steps to which the audio signals may be subjected; and this includes compression. It is thus necessary to devise a system which embodies robust coding, but also permits the act of unauthorized compression to be detected.

W000/75925 discloses the use of a strong watermark and a more fragile watermark including a digital signature. Such digital signatures comprise a payload of, for example, over 2048 bits. Such a large watermark is difficult to insert into an audio signal without being audible. As it is sensitive to data integrity, it will also tend to be corrupted by types of signal processing which the content owner may deem acceptable.

The present invention seeks to address the above-described problems. According to the invention there is provided a system as specified in the claims.

Preferably there is provided a system for detecting compression of audio signals transmitted by way of a communications channel, the system comprising encoding means for imposing upon said audio signals, in a predetermined relationship, first coding signals robust against audio compression and second coding signals vulnerable to contamination by noise when subjected to audio compression, and detection means operative upon signals received by way of said channel; said detection means being conditioned to reject signals contaminated by said noise, and means to compare the relationship between first and second coding signals as received in order to detect variation in said predetermined relationship, thereby to discern whether unauthorized compression has been applied to audio signals received by way of said communications channel.

Preferably said first and second coding signals are similar in nature, but are inserted in different areas of the frequency spectrum of the audio signals and/or at differing levels of modulation.

Further preferably, the said coding signals each comprise a phase modulated carrier frequency.

Preferably still, said first coding signals comprise ICE encoding signals, and said second encoding signals comprise similar signals, inserted at a lower level and/or in a notch disposed within a frequency zone of the audio signals more sensitive to compression than are the first encoding signals.

In a preferred embodiment, the first and second coding signals are inserted in one-to-one relationship into the audio signals.

The first and second coding signals may conveniently be applied simultaneously in respective notches in the frequency spectrum of the audio signals. Alternatively, the first and second coding signals may be applied sequentially, in respective bursts, in the same notch. Importantly, the detection of the coding signals from the audio signals as transmitted through the communications channel includes elements sensitive to noise of the kind introduced by audio signal compression.

Preferably, the first coding signals contain usage rules prescribed by the owner of the signal content. This permits the copyright owner to instruct, in robust code, that signal content is not to be accepted if it has been subjected to compression.

Further preferably, the audio signals are considered to have been subjected to compression, if the predetermined relationship between the first (robust) and second (fragile) codes has been disturbed. In particular, in one preferred embodiment, the original audio signal may contain equal numbers of first (robust) and second (fragile) codes. In these circumstances, the number of robust codes recovered is an indication of the number of fragile codes that were inserted into the original signal. If the number of fragile codes detected is less than expected, then the signal is considered to have been compressed.

### BRIEF DESCRIPTION OF THE DRAWINGS

In order that the invention may be clearly understood and readily carried into effect, some embodiments thereof will now be described, by way of example only, with reference to the accompanying drawings, of which:

FIG. 1 shows, in schematic block-diagrammatic format, a compression detection system;

FIG. 2 shows schematically certain functions of a decision algorithm usable with the system shown in FIG. 1;

FIG. 3 shows in block diagrammatic form a first embodiment of an encoder;

FIGS. 4 and 5 show decoding arrangements usable with the encoder of FIG. 3;

FIG. 6 shows a demodulator;

FIG. 7 shows a second embodiment of an encoder; and

FIG. 8 shows a decoding arrangement usable with the encoder of FIG. 7.

### DETAILED DESCRIPTION OF PREFERRED EMBODIMENTS OF THE INVENTION

Referring now to the drawings, one of the requirements of the invention is that a robust watermark code is embedded, as described above, in the content of an audio recording or transmission; the robust code containing usage rules prescribed by the owner of the program content. In one example, it may be assumed that the prescribed rules are such as to expressly prohibit acceptance of the program if its content has been compressed. Hence, detection of the robust watermark code requires that a decision be made as to whether unauthorized compression of the program content has taken place.

In accordance with the invention, a fragile watermark code, also embedded in the program content but configured to be more vulnerable than the robust watermark code to data compression, is utilized to assist in the making of that decision.

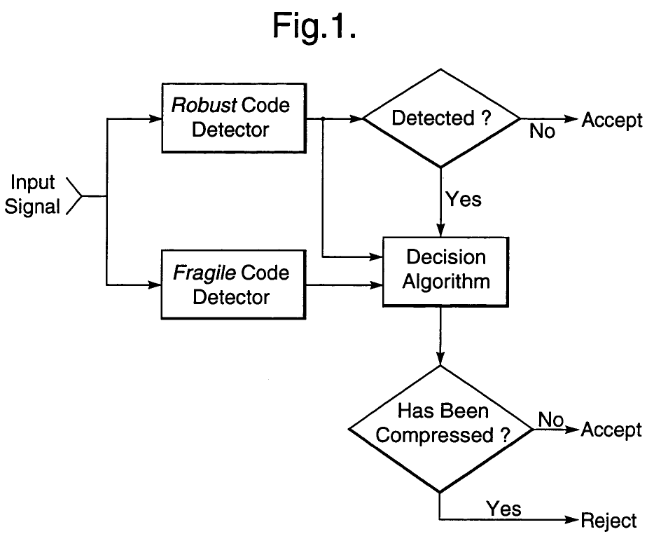

FIG. 1 shows the functionality of a detection arrangement for the dual watermarking system, and it can be seen that an input signal is searched for both robust and fragile codes. If no robust code is found, it is assumed that the received program is not subject to any restriction as to the compression of its content. If, however, the robust code is detected, then it is necessary to apply the respective outputs of robust and fragile code detectors to a decision algorithm configured to determine whether compression of the received program content has taken place and, if so, to reject the program.

It will be appreciated from what has been said earlier that the robust watermark is designed to be persistent and to survive, to the greatest extent possible, all tests, attacks and manipulations to which the program content might be subjected. The fragile watermark, on the other hand, is required to survive typical permitted user manipulations, such as down-mixing, equalization and sampling, but to be compromised by lossy compression. The two watermarks are inserted repeatedly in the audio program, as often as suitable masking conditions are encountered, such that any segment of the audio program will contain robust and fragile codes in a predetermined relationship.

In the following example, the same number of robust codes and fragile codes are inserted; the predetermined relationship thus comprising numerical equality.

In this example, therefore, the decision as to acceptance or rejection of the audio signal is based upon the number of robust and fragile codes that can be extracted from the signal during a decision window interval (typically of duration around 15 seconds) and is based on the following criteria:

(a) Since the original audio program is known to contain equal numbers of robust and fragile codes, the number of robust codes recovered on detection provides an indication of the number of fragile codes that should be recovered;

(b) If the number of fragile codes recovered is lower than expected, then it is assumed that the signal has been tampered with, and this can be verified by examining the difference or ratio between the robust and fragile codes recovered on detection;

(c) Lossy compression has a significantly larger effect upon the fragile codes than that exerted by other user manipulations such as digital-to-analog conversion, down-mixing, equalization, etc.; and

(d) In cases of doubt, where the code recoveries are insufficient to permit reliable judgments to be made as to whether lossy compression has occurred, the system is configured to accept the audio program.

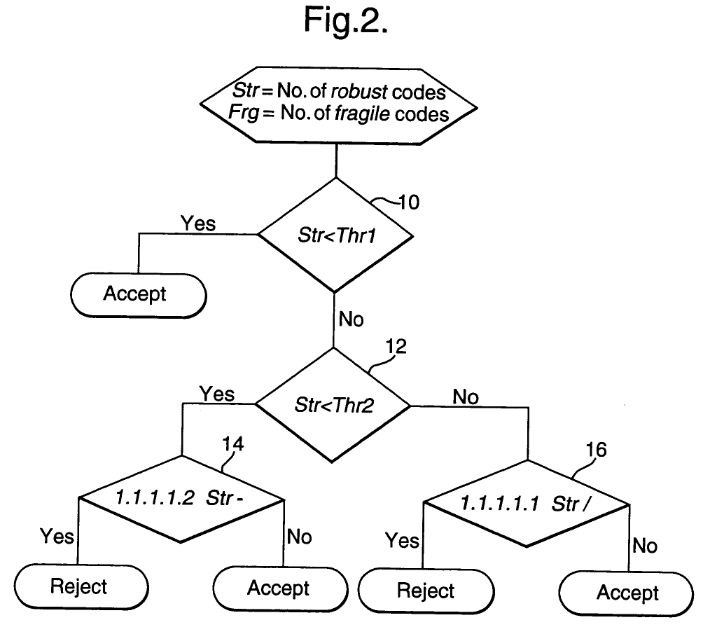

FIG. 2 shows an outline schematic flow diagram that indicates how the decision mechanism, referred to in relation to FIG. 1, can operate.

As can be seen, the first step is to compare at 10 the number “Str” of robust codes detected with a first threshold value, Thr1. If the number of robust codes Str is less than threshold Thr1, then criterion (d) above is assumed to apply, and the program is accepted.

If, on the other hand, the number of robust codes detected exceeds Thr1, the number Str is compared at 12 with a second, higher threshold, Thr2. Depending upon the outcome of the comparison at 12, different comparisons are made, at 14 and 16 respectively, between the numbers of robust and fragile codes detected and acceptance or rejection of the program is determined based upon the outcome of those latter comparisons, as indicated.

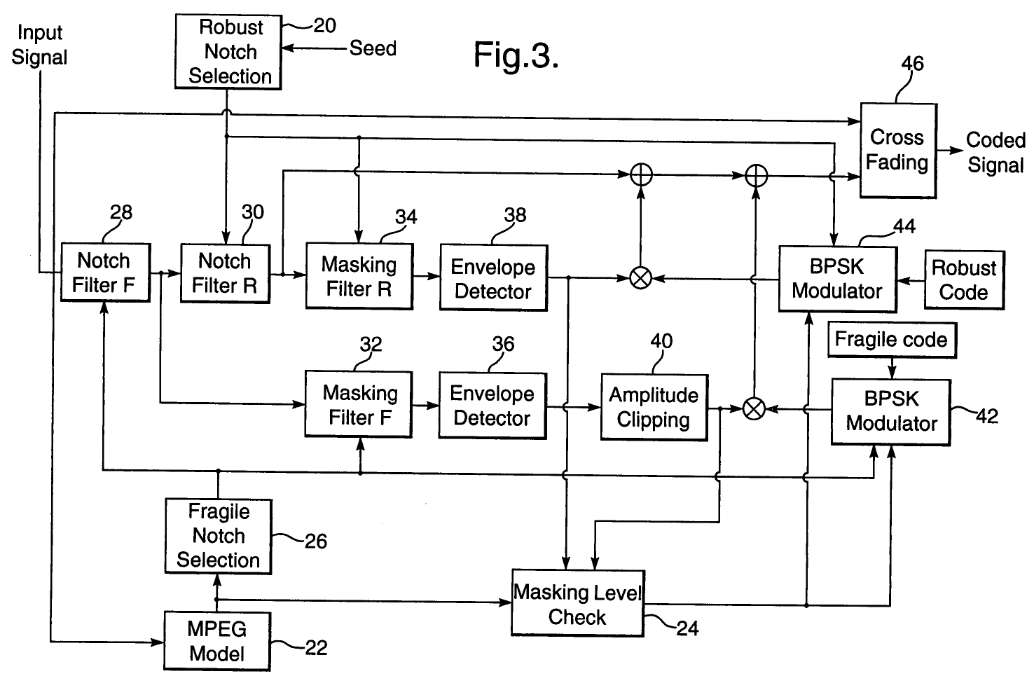

Two detailed embodiments of the invention will now be described in detail, with reference principally to FIGS. 3 to 6 on the one hand and 7 and 8 on the other. In the first of these embodiments, robust and fragile codes are inserted concurrently, at different notch frequencies and as often as the program content permits (bearing in mind the need for the content to mask the codes) into the audio program. In the second embodiment, in contrast, the robust and fragile codes are inserted alternately into a single notch, so as to effect interleaving of the codes. The principal advantage of the second embodiment over the first is a reduction in computational complexity and memory requirements.

Referring now to FIG. 3, there is shown an encoder block diagram for a first embodiment of the invention in which, as mentioned previously, two notches are defined in the audio input signal; one to receive the robust code and the other to receive the fragile code. The placement of the two notches, in terms of absolute frequency, can vary from time to time, in accordance with a known sequencing, if the so-called frequency-hopping procedure is invoked to provide added security against “hacking” attempts to discover and replicate the codes utilized but, in any event, the two codes are always inserted simultaneously into their respectively assigned notches provided suitable masking conditions exist. In each case, the “watermarking” code consists of a start sentinel pattern followed by the payload bits.

At any instant of operation, the frequency of the notch assigned to receive the next robust code is selected from a number of candidate notch frequencies in a pseudo-random manner; the objective being to enhance the security of the system by implementing a form of frequency-hopping, as mentioned above. The process is initialized at 20 with a seed number and a new notch frequency is selected after the insertion of each robust watermarking code has been completed.

The input audio signal is fed at 22 through a psycho-acoustic model, similar to that employed in the MPEG audio coding standards, the model being configured to perform a frame-by-frame, frequency-based analysis to determine the masking thresholds at different frequency bands. The model's output is used at 24 to control the insertion of watermarking codes and at 26 to determine the notch frequency for the next fragile code among a number of candidate frequencies; the intention being to ensure that the fragile code is inserted into a notch in a part of the frequency spectrum where the effects of coding distortion are expected to be significant, and thus more likely to result in corruption of the fragile code. It is to be stressed that the intention is to so position the fragile code that it will be vulnerable to corruption by lossy compression. Thus if there are several candidate notch frequencies into which the fragile code could be inserted, the one selected is that in which the fragile code is likely to suffer the highest distortion after the audio signal as a whole has been subjected to compression. This may be, for example, the notch exhibiting the highest masking threshold.

The input program audio signal is filtered at 28 and 30 by two notch filters (F and R) centered respectively at the notch frequencies selected for the fragile and robust codes. The notch filter outputs are passed through respective masking filters 32, 34, and then through respective envelope detectors 36, 38, to generate the insertion levels for the two codes. In addition, an amplitude clipping operation is applied at 40 after the envelope detecting stage in the fragile watermark coding chain to prevent the fragile watermarking code from exceeding a predetermined value. The effect of keeping the code insertion level low is to make the fragile watermark more difficult to detect when the audio signal as a whole has been distorted by compression. This, of course, further increases the vulnerability of the fragile watermarking codes to compressive procedures.

As is conventional, code insertion is initiated when suitable masking conditions exist, according to the masking levels evaluated by the MPEG-like model. The insertion of the robust and fragile codes is initiated simultaneously at their respective notch frequencies; the code bits being inserted, in this example, by Binary Phase Shift Keying (BPSK) of respective carriers at the centre frequencies of the two notches. Respective BPSK modulators 42, 44, are enabled or disabled in dependence upon the masking situation; a cross-fader 46 being employed to provide a smooth transition between the original and coded signals where frequency-hopping is employed.

At this point, prior to describing the decoding components of the system, it is convenient to recall that the fragile watermark has been rendered deliberately vulnerable to the application to the audio program of compressive procedures by:

(a) inserting the fragile code into a notch at a frequency where coding distortion is expected to be high if compression occurs, and

(b) inserting the fragile code at a low amplitude level.

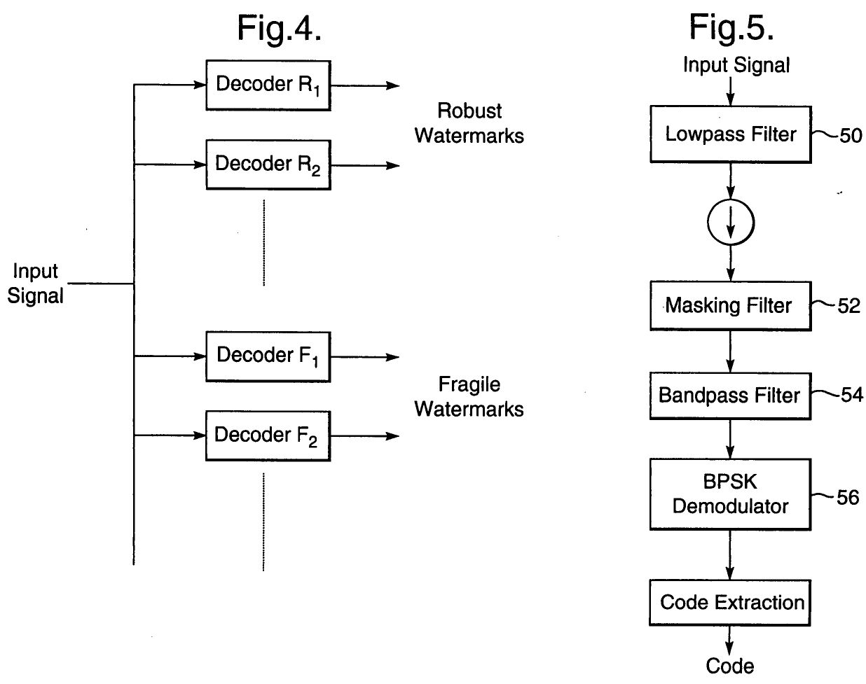

Turning now to the decoding operation, as shown schematically and in broad concept only in FIG. 4, a bank of decoders is needed in order to monitor each of the candidate notch frequencies at which robust or fragile codes may have been inserted, in order to accommodate the frequency-hopping process. FIG. 5 shows, in block-diagrammatic form, a typical decoder that can be used as one of such a bank.

In the decoder of FIG. 5, the watermark-encoded signal as received is passed through a low-pass filter 50 and then down-sampled. This has the effect of reducing the computational complexity of the decoder without any loss of information, since the notches into which the watermarking codes are inserted are located in the lower part of the frequency spectrum. The down-sampled signal is passed through a masking filter 52 and then a band-pass filter 54 centered upon the notch frequency which is monitored by the decoder, and the output of the band-pass filter is fed to a BPSK demodulator 56.

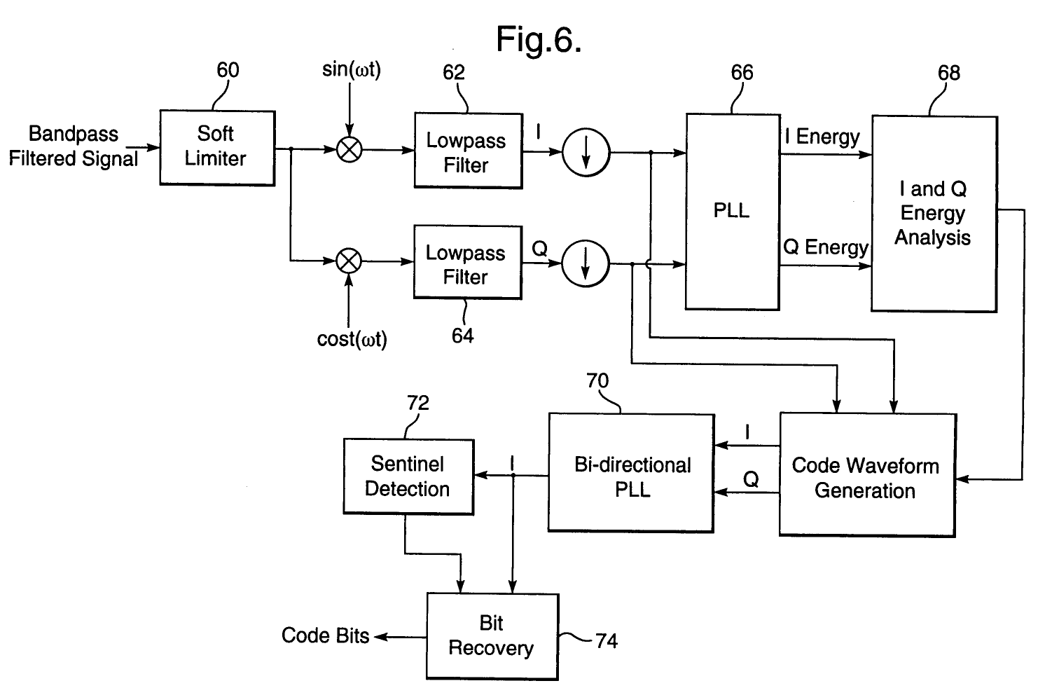

FIG. 6 shows a block diagram describing the principal operations of the BPSK demodulator. The band-pass filtered signal (see FIG. 5) is soft limited at 60 and then converted into base-band I and Q signal streams by multiplication with reference sine waves. The I and Q signals are each separately subjected, at 62, 64 respectively, to low-pass filtering and down-sampling and are then applied to a second order phase locked loop (PLL) 66.

When the Q energy at the output of the loop 66 is below a threshold, this indicates that a code is likely to be present. In these circumstances, a section of the I and Q waveforms is stored for analysis.

The setting of the Q energy threshold level can be used to adjust the sensitivity of the demodulator to noisy signals. Thus, any decoders uniquely associated with the detection of fragile codes can be tuned to render them more sensitive to the presence of noise (such as may indicate that compression has taken place) by setting the Q energy threshold at a relatively low value.

During the BPSK demodulation, the presence of a code is sensed at 68 by the presence of low energy (ideally 0) in the Q channel. Certain noise-like distortions of the signal (e.g. white noise and compression) have the effect of increasing the energy in the Q channel. Thus code extraction is initiated when the Q channel energy falls below a fixed threshold. For the decoding of robust watermarking codes, an optimum threshold value ThR is selected to give good robustness to manipulations of the audio signal and no false positives. For the decoding of fragile watermarking codes, a threshold value ThF is selected which is significantly smaller than ThR. In general, the smaller the value of ThF, the more sensitive the decoder will be to signal distortion because whenever the energy in the Q channel of the fragile watermarking code detector exceeds ThF, no codes will be extracted.

Analysis of the stored I and Q data involves re-running the PLLs since the original PLL will not have locked until the first few bits had passed. By starting in the middle of the stored waveform, a new PLL 70 is run backwards and forwards using the same phase stored from the earlier PLL block. An attempt is then made at 72 to find a start sentinel pattern in the I waveform. If successful, the remaining bits of the watermarking code's payload are recovered at 74.

It will be appreciated that the decoders for the fragile watermarking codes are configured to be more sensitive to noise than are the decoders associated with the robust watermarking codes. Thus the presence of even small amounts of noise (e.g. quantization noise) leads to the non-recovery of the fragile codes.

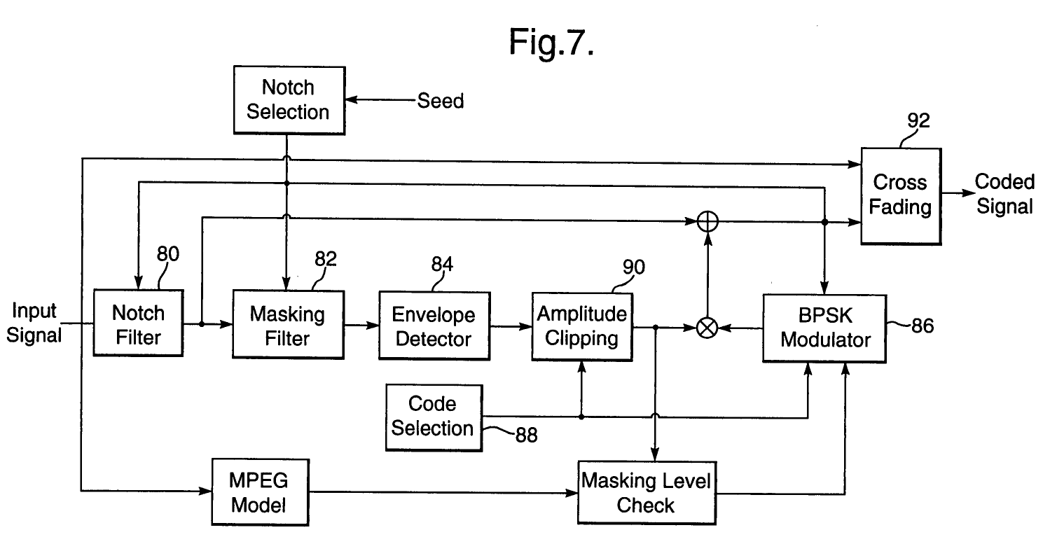

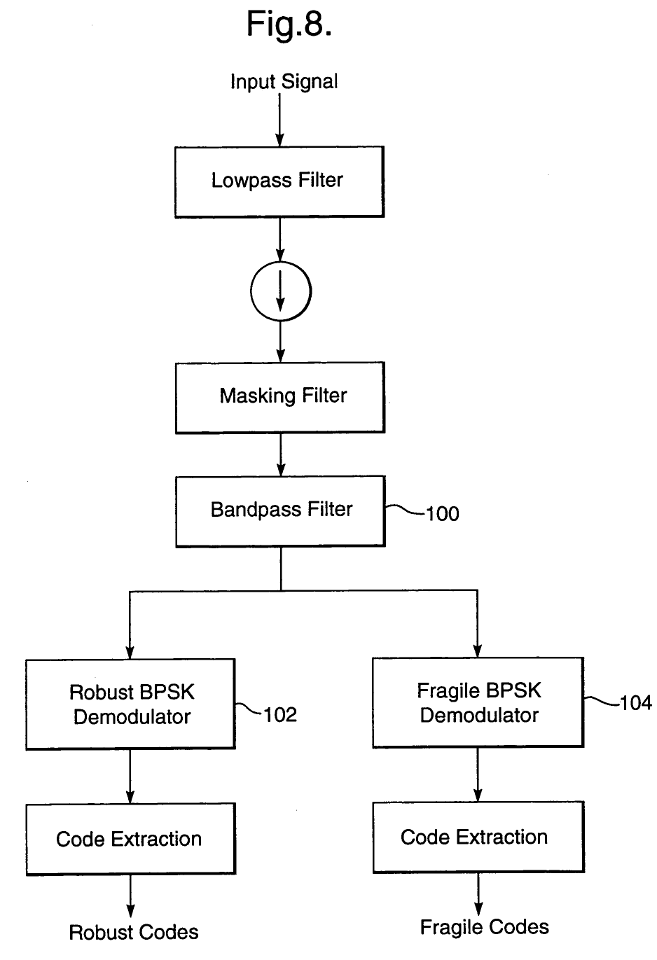

A second embodiment of the invention will now be described with reference to FIGS. 7 and 8, which respectively show suitable encoding and decoding arrangements.

In a system operated in accordance with the encoding principles implemented in the arrangement of FIG. 7, the robust and fragile codes are inserted alternately in the same notch. Frequency-hopping can still be used, as described earlier, provided that each notch defined in the hopping procedure is held for sufficient time to allow at least two insertions (one robust and one fragile) to be made. In practice, the rate at which frequency hopping is implemented is rarely sufficiently rapid to present difficulties in this respect.

The processing path for the input audio signal is similar to that described above in relation to FIGS. 3 to 6. The input samples are passed through a bandstop filter 80 to generate a notch, and then through a masking filter 82 and envelope detector 84 to evaluate the appropriate code insertion levels. The MPEG-like model is used, as before, to evaluate the masking thresholds and the BPSK modulator 86 is enabled when the masking conditions are satisfied in order to initiate code insertion.

A code selector 88 is used to act as a switch between the robust and fragile code generation, actuating so as to ensure that, when a fragile code is to be inserted, amplitude clipping is enabled at 90 to insert the code at a low level with the objectives described earlier. The cross-fader 92 provides a smooth transition between the original and coded signals when frequency-hopping occurs.

At the decoding stage, a bank of decoders is needed to monitor each of the candidate notch frequencies at which the robust/fragile code sequences are inserted. As illustrated in FIG. 8, in each such decoder the configured to effect low pass filtering and sub-sampling in order to reduce computational complexity.

The output of the band pass filter 100 is fed to two BPSK demodulators 102, 104, one each for the robust and fragile codes. Whilst the operation of the two BPSK demodulators is the same as described above, they are configured with different parameter values. In the present case, the Q channel energy threshold to trigger the decoding analysis is set to a lower value for the fragile code detector. Thus the fragile code demodulation is more sensitive to noise than is the corresponding operation for robust codes.

An important feature of the present invention is that the fragile watermark is sensitive to a particular type of signal processing, whilst being more robust to other types of signal processing. The above embodiments have been directed to the case where the fragile watermark is sensitive to lossy compression, such as low bit rate compression such as AAC, MP3, or Q-Design, but is robust to the group comprising, for example:

a. Processing done inside a DVD player, such as mix-down and downsampling;

b. Degradation due to popular consumer reproduction, such as noise addition such as wow and flutter, D/A and A/D conversion;

c. Echo addition;

d. linear speed change;

e. Equalization;

f. Amplitude compression; and,

g. Processing done at broadcasting studios such as Time scale modification, amplitude compression, band-pass filtering;

Of course, through careful choice of the parameters for the code insertion such as insertion frequency, it will be possible to create a fragile watermark which will be sensitive to any one of the group of processes listed above, but more robust to the others. Additionally, it is possible to insert more than one type of fragile watermark, each type being more sensitive to a respective one of said group of processes.

Although in the above embodiments a combination of strong and fragile watermarks has been used, it is possible to use only a fragile watermark if desired. The role of the strong watermark can be played by the fragile watermark itself, provided information is inserted in the payload of the fragile watermark to enable the number of fragile watermarks originally inserted in the given audio signal to be determined. One can then compare the number of watermarks retrieved with the number originally inserted to determine whether unauthorized signal processing has been performed.

Although the invention has been described herein with reference to specific embodiments and examples, those skilled in the art will recognize that the invention may be implemented in various ways, depending upon the external operating parameters and criteria to which the audio input signals may need to satisfy in different operational circumstances. It is therefore not intended that the detailed features of the embodiments described herein should restrict or limit the scope of the invention.

1. A system for detecting compression of audio signals transmitted by way of a communications channel, the system comprising an encoder imposing upon said audio signals, in a predetermined relationship, first coding signals robust against audio compression and second coding signals vulnerable to contamination by noise when subjected to audio compression, and a detector operative upon signals received by way of said channel; said detector being conditioned to reject signals contaminated by said noise, and a comparator comparing the relationship between first and second coding signals as received in order to detect variation in said predetermined relationship, thereby to discern whether unauthorized compression has been applied to audio signals received by way of said communications channel.

2. A system according to claim 1 wherein said first and second coding signals are similar in nature, but are inserted in different areas of the frequency spectrum of the audio signals and/or at differing levels of modulation.

3. A system according to claim 1 wherein the said coding signals each comprise a phase modulated carrier frequency.

4. A system according to claim 1 wherein said first and second coding signals comprise similar code sequence signals, the second coding signals being inserted at a lower level and/or in a notch disposed within a frequency zone of the audio signals more sensitive to compression than are the first coding signals.

5. A system according to claim 1 wherein the first and second coding signals are inserted in one-to-one relationship into the audio signals.

6. A system according to claim 1 wherein the first and second coding signals are simultaneously inserted into respective notches in the frequency spectrum of the audio signals.

7. A system according to claim 1 wherein the first and second coding signals are inserted sequentially, in respective bursts, in the same notch.

8. A system according to claim 1 wherein the detection of the second coding signals from the audio signals as transmitted through the communications channel includes elements sensitive to noise of the kind introduced by audio signal compression.

9. A system according to claim 1 wherein the first coding signals contain usage rules prescribed by the owner of the signal content.

10. A system according to claim 1 wherein the audio signals are considered to have been subjected to compression if the predetermined relationship between the first (robust) and second (fragile) codes has been disturbed.

11. A system according to claim 10 wherein the number of robust codes recovered is used as an indication of the number of fragile codes that were inserted into the audio signal.

12. A system for detecting a first type of signal processing having been applied to audio signals transmitted by way of a communications channel, the system comprising an encoder imposing upon said audio signals, in a predetermined relationship, first coding signals robust against said first type of signal processing, and second coding signals vulnerable to contamination by noise when subjected to said first type of signal processing, and a detector operative upon signals received by way of said channel; said detector being conditioned to reject signals contaminated by said noise, and a comparator comparing the relationship between first and second coding signals as received in order to detect variation in said predetermined relationship, thereby to discern whether unauthorized signal processing of the first type has been applied to audio signals received by way of said communications channel, characterized in that said second coding signals are robust against other types of signal processing.

13. A system as claimed in claim 12 in which said second coding signals are vulnerable to one member of the group of signal processing procedures consisting of: low bit rate, lossy compression, mix-down, downsampling, equalization, echo addition, linear speed change, amplitude compression, time scale modification, band-pass filtering, and noise addition; and in which said second coding signals are more robust to the other members of said group of signal processing procedures.

14. A system as claimed in claim 13 in which further types of coding signal are inserted into the audio signals, each type being vulnerable to a different member of said group of signal processing procedures.

15. A system for detecting a first type of signal processing having been applied to audio signals transmitted by way of a communications channel, the system comprising an encoder imposing upon said audio signals coding signals vulnerable to contamination by noise when subjected to said first type of signal processing, the coding signals including information as to the number of coding signals originally applied to the audio signal, and a detector operative upon signals received by way of said channel; said detector being conditioned to reject signals contaminated by said noise, and a comparator comparing the number of uncontaminated coding signals received with the number originally applied, thereby to discern whether unauthorized signal processing of the first type has been applied to audio signals received by way of said communications channel, characterized in that said coding signals are robust against other types of signal processing.
